(19) United States
(12) Patent Application Publication
(10) Pub. No.: US 2026/0290222 A1
(43) Pub. Date: Sep. 24, 2026

(54) DISPLAY SUBSTRATE AND DISPLAY DEVICE

(71) Applicants: Chengdu BOE Optoelectronics Technology Co., Ltd., Chengdu (CN); BOE Technology Group Co., Ltd., Beijing (CN)

(72) Inventor: Hongqiang LUO, Beijing (CN)

(21) Appl. No.: 19/475,904

(22) PCT Filed: Oct. 21, 2024
(86) PCT No.: PCT/CN2024/126083

§ 371 Date: Oct. 16, 2025

(30) Foreign Application Priority Data
Nov. 8, 2023 (CN) 202311480555.6

(51) Int. Cl. G09G 3/20; G06F 3/041

(52) U.S. Cl. CPC G09G 3/2096; G06F 3/0412; G09G 2300/0842; G09G 2310/0267; G09G 2310/0275; G09G 2310/08; G09G 2320/0276; G09G 2330/021; G09G 2370/10

(57) ABSTRACT

The present disclosure provides a display substrate and a display device. The display substrate includes a first chip configured to output, in response to receiving an initial touch signal from a touch display panel, a target touch signal based on the initial touch signal; and a second chip electrically connected to the first chip and configured to output a touch data signal to a main control unit based on the target touch signal, and output, in response to receiving an image data signal from the main control unit, a timing control signal and a display data signal based on the image data signal; wherein the first chip is further configured to receive the timing control signal and the display data signal, and output a gate drive signal and a data voltage signal to the touch display panel.

### CROSS REFERENCE TO RELATED APPLICATION(S)

This application claims priority to Chinese Patent Application No. 202311480555.6, filed on Nov. 8, 2023, the entire content of which is incorporated herein in its entirety by reference.

### TECHNICAL FIELD

The present disclosure relates to a technical field of display and touch, and in particular to a display substrate and a display device.

### BACKGROUND

Touch and Display Driver Integration (TDDI) products have been widely used due to their advantages such as high touch sensitivity and thinness. A TDDI product includes a touch module and a display module. The touch module and the display module are independently controlled by two chips respectively, which leads to a low degree of integration of TDDI products.

### SUMMARY

The present disclosure provides a display substrate and a display device.

According to a first aspect, the present disclosure provides a display substrate. The display substrate includes: a first chip configured to output, in response to receiving an initial touch signal from a touch display panel, a target touch signal based on the initial touch signal; and a second chip electrically connected to the first chip and configured to output a touch data signal to a main control unit based on the target touch signal, and output, in response to receiving an image data signal from the main control unit, a timing control signal and a display data signal based on the image data signal; in which the first chip is further configured to receive the timing control signal and the display data signal, and output a gate drive signal and a data voltage signal to the touch display panel based on the timing control signal and the display data signal.

For example, the first chip includes: a touch analog circuit configured to output, in response to receiving the initial touch signal, the target touch signal based on the initial touch signal; and a display analog circuit configured to receive the timing control signal and the display data signal, and output the gate drive signal and the data voltage signal based on the timing control signal and the display data signal.

For example, the second chip includes: a touch digital circuit configured to receive the target touch signal and output a touch data signal based on the target touch signal; and a display digital circuit configured to output, in response to receiving the image data signal, the timing control signal and the display data signal based on the image data signal.

For example, the first chip includes: a first control unit, a plurality of signal input/output interfaces, a plurality of analog front ends, a power management unit, a source driver unit, a gamma correction unit, and a gate driver unit.

For example, the second chip includes: a storage unit, a second control unit, an oscillator, a voltage regulator, a first protocol interface, a second protocol interface, and a communication interface.

For example, the plurality of analog front ends are divided into two groups of analog front ends respectively arranged on both sides of the first control unit along a first direction; the power management unit is arranged on a first side of the first control unit along a second direction orthogonal to the first direction; and the source driver unit, the plurality of signal input/output interfaces, the gate driver unit and the gamma correction unit are arranged on a second side of the first control unit along the second direction; in which the source driver unit is divided into two groups of source driver units symmetrically distributed about the gamma correction unit, the gate driver unit is divided into two groups of gate driver units symmetrically distributed about the gamma correction unit, and the plurality of signal input/output interfaces are divided into two groups of signal input/output interfaces symmetrically distributed about the gamma correction unit.

For example, the storage unit is arranged on a first side of the second control unit along a second direction; the first protocol interface, the second protocol interface and the communication interface are arranged on a second side of the second control unit along the second direction; and the oscillator and the voltage regulator are arranged on a side of the second control unit along a first direction orthogonal to the second direction.

For example, the first chip is arranged in a non-display area of the touch display panel.

For example, the second chip is arranged in the non-display area of the touch display panel.

For example, the second chip is arranged on a flexible circuit board between the touch display panel and a main board, where the main control unit is disposed on the main board.

For example, the display substrate further includes: a flash memory electrically connected to the second chip and arranged on a flexible circuit board between the touch display panel and a main board.

For example, the second chip further includes a flash memory packaged inside the second chip.

For example, the second chip is electrically connected to the flash memory via a communication interface.

For example, the first chip is electrically connected to the second chip via a second protocol interface, a plurality of communication interfaces, a first interrupt interface, a synchronization signal interface, and a gate signal input interface, and the first chip and the second chip share a common ground via a first ground interface.

For example, the first chip is electrically connected to the main control unit via a first power interface and a first reset interface, and the first chip and the main control unit share a common ground via a second ground interface.

For example, the first chip is electrically connected to the touch display panel via a gate signal output interface, a source signal output interface, a signal input/output interface, an initialization interface, and a shield signal interface, and the first chip and the touch display panel share a common ground via a third ground interface.

For example, the second chip is electrically connected to the main control unit via a power control interface, a second power interface, a general purpose input/output port, a first protocol interface, a second reset interface, a second interrupt interface, a communication bus interface and a communication interface, and the second chip and the main control unit share a common ground via a fourth ground interface.

According to a second aspect, the present disclosure provides a display device. The display device includes: a touch display panel configured to generate an initial touch signal in response to a received touch operation; the display substrate provided by the embodiments of the present disclosure, electrically connected to the touch display panel and configured to generate the target touch signal based on the initial touch signal, and output the touch data signal based on the target touch signal; and the main control unit electrically connected to the display substrate and configured to generate the image data signal based on the touch data signal; in which the display substrate is further configured to generate the timing control signal and the display data signal based on the image data signal, and output the gate drive signal and the data voltage signal to the touch display panel based on the timing control signal and the display data signal.

### BRIEF DESCRIPTION OF THE DRAWINGS

FIG. 1 shows a schematic structural diagram of a display substrate according to an embodiment of the present disclosure;

FIG. 2 shows a schematic structural diagram of a display substrate according to another embodiment of the present disclosure;

FIG. 3 shows a schematic structural diagram of a first chip according to an embodiment of the present disclosure;

FIG. 4 shows a schematic structural diagram of a second chip according to an embodiment of the present disclosure;

FIG. 5 shows a schematic structural diagram of a first chip according to another embodiment of the present disclosure;

FIG. 6 shows a schematic structural diagram of a second chip according to another embodiment of the present disclosure;

FIG. 7A shows a schematic structural diagram of a display device according to an embodiment of the present disclosure;

FIG. 7B shows a schematic structural diagram of a display device according to another embodiment of the present disclosure;

FIG. 8A shows a schematic structural diagram of a display device according to another embodiment of the present disclosure;

FIG. 8B shows a schematic structural diagram of a display device according to another embodiment of the present disclosure;

FIG. 8C shows a schematic structural diagram of a display device according to another embodiment of the present disclosure; and

FIG. 8D shows a schematic structural diagram of a display device according to another embodiment of the present disclosure.

### DETAILED DESCRIPTION OF EMBODIMENTS

In order to make the objectives, technical solutions and advantages of the embodiments of the present disclosure clearer, the technical solutions in the embodiments of the present disclosure will be clearly and completely described below in conjunction with the drawings in the embodiments of the present disclosure. Obviously, the described embodiments are only a part of the embodiments of the present disclosure, but not all of them. Based on the described embodiments of the present disclosure, all the other embodiments obtained by those of ordinary skills in the art without any creative effort are within the scope of protection of the present disclosure. In the following description, some specific embodiments are only used for illustrative purposes and should not be understood as limiting the present disclosure in any way. They are merely examples of the embodiments of the present disclosure. Conventional structures or constructions will be omitted when they may cause confusion in the understanding of the present disclosure. It should be noted that the shapes and sizes of the components in the drawings do not reflect the actual sizes and proportions, but merely illustrate the contents of the embodiments of the present disclosure.

Unless otherwise defined, technical or scientific terms used in the embodiments of the present disclosure should have the general meanings understood by those skilled in the art. The terms “first”, “second” and the like used in the embodiments of the present disclosure do not indicate any order, quantity or importance, but are only used to distinguish different constituent portions.

In addition, in the description of the embodiments of the present disclosure, the term “connected to” or “connected” may refer to a direct connection between two components, or may refer to a connection between two components via one or more other components, and the connection manner is electrical connection or electrical coupling. Furthermore, the two components may also be connected or coupled in a wired or wireless manner.

Typically, a display module of a TDDI product is controlled by a Display Driver Integrated Circuit (DDIC), and a touch module is controlled by a Touch Integrated Circuit (TIC). Both the DDIC and the TIC include two portions, i.e., analog circuits and digital circuits. By adopting the advanced process technology, the degree of integration of the analog circuits and the digital circuits may be improved, thereby reducing the areas of the DDIC and the TIC.

With the improvement of the process technology, the area of the digital circuits will gradually decrease according to Moor's Law, while the area of the analog circuits will not change much. This leads to an increase in the area ratio of the analog circuits on the wafer. For example, in the case of using 40 nm process technology, the area of the analog circuits of the DDIC accounts for 50%, while the area of the digital circuits of the DDIC accounts for 50%. In the case of using 28nm process technology, the area of the analog circuits of the DDIC accounts for 60%, while the area of the digital circuits accounts for 40%.

Since the manufacturing process cost of the 28 nm process node is much higher than that of the 40 nm process node, the cost the DDIC of the 28 nm process node is much higher than that of the DDIC of the 40 nm process node, but the area of the DDIC is not significantly reduced.

In addition, with the continuous development of the TDDI technology, the DDIC is constantly being updated and upgraded, and the upgrade object of the DDIC is usually the digital circuit portion of the DDIC. However, the upgrade process of the digital circuit of the DDIC requires corresponding operations such as re-design, tape-out, and packaging of the DDIC, which will also make the cost of the development and upgrade of the DDIC too high.

Considering the above problems, the present disclosure provides a display substrate. The display substrate includes: a first chip configured to output, in response to receiving an initial touch signal from a touch display panel, a target touch signal based on the initial touch signal; and a second chip electrically connected to the first chip and configured to output a touch data signal to a main control unit based on the target touch signal, and output, in response to receiving an image data signal from the main control unit, a timing control signal and a display data signal based on the image data signal; in which the first chip is further configured to receive the timing control signal and the display data signal, and output a gate drive signal and a data voltage signal to the touch display panel based on the timing control signal and the display data signal.

Hereinafter, various embodiments according to the present disclosure will be described in detail with reference to the accompanying drawings. It should be noted that, in the drawings, same reference signs are given to constituent parts having substantially the same or similar structures and functions, and repeated descriptions thereof will be omitted.

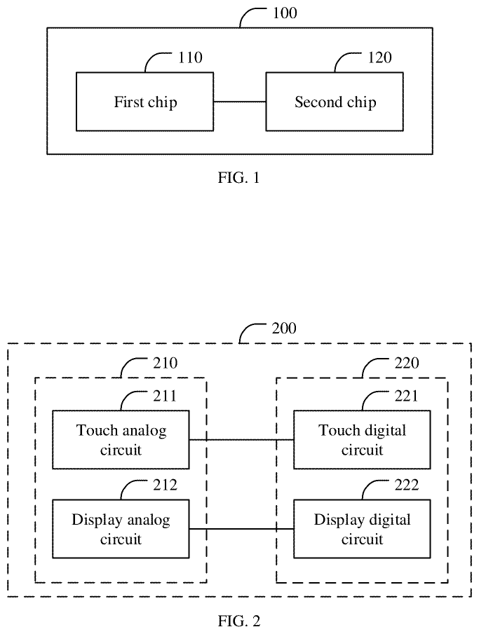

FIG. 1 shows a schematic structural diagram of a display substrate according to an embodiment of the present disclosure.

As shown in FIG. 1, the display substrate 100 includes a first chip 110 and a second chip 120 electrically connected to the first chip 110.

In the embodiment of the present disclosure, when the display substrate 100 implements a touch function, the first chip 110 outputs a target touch signal based on an initial touch signal in response to receiving the initial touch signal from a touch display panel,. The second chip 120 outputs a touch data signal to a main control unit based on the target touch signal.

For example, the initial touch signal is obtained by the touch display panel based on a touch operation performed by a user on the touch display panel. The initial touch signal indicates a touch instruction corresponding to the touch operation of the user. The first chip 110 converts the initial touch signal into a target touch signal. For example, the initial touch signal may be an analog signal. The first chip 110 may process the analog signal by performing operations such as filtering, signal amplification, frequency conversion, demodulation, and level adjustment on the analog signal, and convert the processed analog signal into a digital signal. The digital signal is the target touch signal.

The second chip 120 processes the target touch signal to generate a touch data signal. The touch data signal indicates touch data information, such as touch coordinates. The second chip 120 may send the touch data signal to an external main control unit to cause the main control unit to update a display screen based on the touch data signal.

For example, the initial touch signal may be received by using a plurality of touch electrodes of the display substrate. For example, the plurality of touch electrodes may be arranged on a first side and a second side of the touch display panel, and the first side is orthogonal to the second side. For example, the coordinates of the touch operation in a horizontal direction (x direction) may be determined by the plurality of touch electrodes distributed on the first side, and the coordinates of the touch operation in a vertical direction (y direction) may be determined by the plurality of touch electrodes distributed on the second side.

For example, the first chip 110 may determine the initial touch signal by detecting voltages of the plurality of touch electrodes. For example, when no touch operation occurs on the touch display panel, the voltages fed back by the plurality of touch electrodes are uniform, for example, the voltages are all 10V. When a touch operation occurs on the touch display panel, the voltage of the touch electrode in the area corresponding to this touch operation changes, while the voltages of the touch electrodes in other areas remain unchanged. For example, the voltage of the touch electrode in the area corresponding to this touch operation is 5V, and the voltages of the touch electrodes in other areas remain 10V.

The first chip 110 acquires the voltages of the plurality of touch electrodes to determine the initial touch signal, performs operations such as filtering, signal amplification, and conversion from analog signal into digital signal on the initial touch signal, and then outputs the target touch signal to the second chip 120. The second chip 120 may determine the coordinates of the touch operation based on the voltages of the plurality of touch electrodes indicated by the target touch signal, thereby generating a touch data signal, such that the main control unit may output a new display screen based on the coordinates of the touch operation indicated by the touch data signal.

In the embodiment of the present disclosure, the first chip 110 may acquires the voltages of the plurality of touch electrodes in real time. When no touch operation occurs on the touch display panel, it is also possible to send a target touch signal to the second chip 120 at a fixed sending frequency based on the current touch electrode voltage. At this time, the voltages of the plurality of touch electrodes indicated by the target touch signal are uniform and consistent, and the main control unit determines that no touch operation occurs on the current touch display panel based on the target touch signal.

For example, when no touch operation occurs on the touch display panel, the first chip 110 may output the target touch signal at a lower frequency, such as 30 Hz. When a touch operation occurs on the touch display panel, the first chip 110 may output the target touch signal at a higher frequency, such as 120 Hz. This may reduce the power consumption of the display substrate when no touch operation occurs on the touch display panel, and increase the acquisition frequency of the initial touch signal to improve the accuracy of touch information when a touch operation occurs on the touch display panel.

In the embodiment of the present disclosure, when the display substrate 100 implements the display function, the second chip 120 outputs a timing control signal and a display data signal based on an image data signal in response to receiving the image data signal from the main control unit. The first chip 110 receives the timing control signal and the display data signal, and outputs a gate drive signal and a data voltage signal Vdata to the touch display panel based on the timing control signal and the display data signal.

For example, the image data signal indicates image data. For example, the image data signal may be image data output by the main control unit based on a display instruction, or may be image data generated by the main control unit based on touch data. The image data signal may represent a pixel value of each pixel in the image data.

The second chip 120 processes the image data signal to generate a timing control signal and a display data signal. For example, the second chip 120 may perform operations such as amplification, reduction, and sharpening on the image data, and convert the image data into a voltage signal. The voltage signal is a timing control signal used to control a timing change of a drive signal.

The first chip 110 generates a gate drive signal and a data voltage signal based on the timing control signal and the display data signal. For example, the timing control signal may include a gate control signal and a source control signal. The first chip 110 outputs a gate drive signal based on the gate control signal, so as to scan a pixel array in the touch display panel line by line. The first chip 110 outputs a data voltage signal based on the source control signal and the display data signal. The data voltage signal is sequentially applied to pixel units scanned by the gate drive signal. The data voltage signal and the gate drive signal are output to the pixel array of the touch display panel to drive the touch display panel to display the image data represented by the image data signal.

For example, the display data signal may represent different pixel values of a pixel point in the form of voltage. The first chip 110 may use a gamma voltage as a reference voltage to divide the voltage of the display data signal to obtain voltages representing a plurality of grayscale values, thereby obtaining a data voltage signal.

In the embodiment of the present disclosure, the first chip 110 processes an analog signal generated in a touch process and a display process, converts the analog signal into a digital signal, and outputs the digital signal to the second chip 120. The second chip 120 may process a digital signal generated in the touch process and the display process, and output the processed digital signal to the first chip 110. The first chip 110 may convert the digital signal from the second chip 120 into an analog signal and process the analog signal.

For example, the first chip 110 may receive an analog signal indicating touch information from the touch display panel, convert the analog signal into a digital signal indicating touch information, and then output the digital signal to the second chip 120. The second chip 120 generates touch data based on the digital signal indicating the touch information, and outputs the touch data to the main control unit, so as to enable the main control unit to generate corresponding image data based on the touch data.

For example, the second chip 120 receives image data from the main control unit, converts the image data into a digital signal indicating image information, and then outputs the digital signal indicating the image information to the first chip 110. The first chip 110 may perform operations such as filtering, voltage amplification, buffering, latching, and level conversion on the digital signal indicating the image information, and convert the processed digital signal into an analog signal (a data voltage signal) representing the image data. The second chip 110 outputs the analog signal to the touch display panel to cause the touch display panel to display image data based on the analog signal.

In the embodiment of the present disclosure, a signal representing image data may be transmitted between the first chip 110 and the second chip 120 based on an image signal transmission protocol, and a signal representing touch information may be transmitted therebetween based on a communication interface.

In the embodiment of the present disclosure, the first chip 110 may be equivalent to an analog circuit chip, and support functions of analog circuits in a DDIC and a TIC. The second chip 120 may be equivalent to a digital circuit chip, and support functions of digital circuits in the DDIC and the TIC.

Through the embodiment of the present disclosure, the analog circuits in the DDIC and the TIC are integrated into a single chip to form the first chip 110, and the digital circuits in the DDIC and the TIC are integrated into a single chip to form the second chip 120. A low process technology (40 nm, 55 nm, 90 nm or even higher process technology) may be used for the first chip 110 to reduce the production cost of the display substrate 100. In addition, the use of the low process technology may reduce leakage currents in the analog circuits and lower the static power consumption of the first chip 110. A high process technology (28 nm, 22 nm, 14 nm, etc.) is used for the second chip 120, so that the degree of integration of the second chip 120 may be improved and the area of the second chip 120 may be reduced. In addition, channels of the second chip 120 prepared using the high process technology are shallow, and the second chip 120 may operate under a drive of a smaller voltage, thereby reducing the dynamic power consumption of the second chip 120.

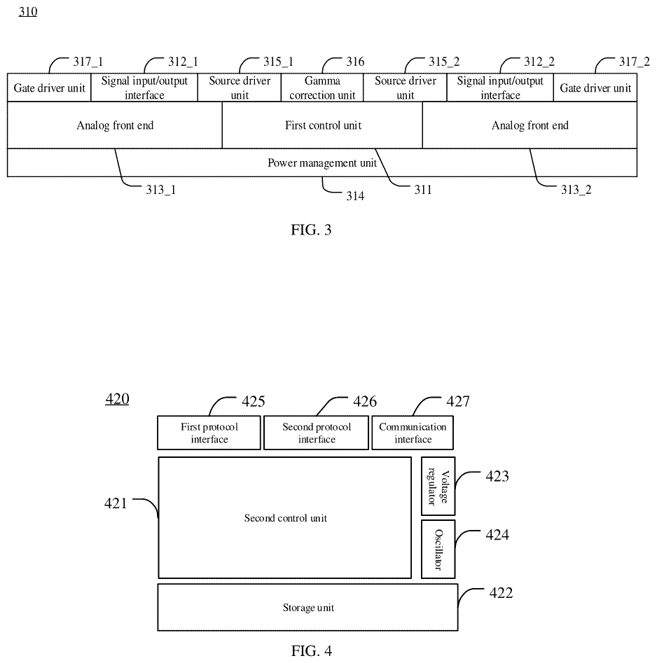

FIG. 2 shows a schematic structural diagram of a display substrate according to another embodiment of the present disclosure.

As shown in FIG. 2, the display substrate 200 includes a first chip 210 and a second chip 220.

In the embodiment of the present disclosure, the first chip 210 includes a touch analog circuit 211 and a display analog circuit 212. The second chip 220 includes a display digital circuit 221 and a display digital circuit 222.

In the embodiment of the present disclosure, the first chip 210 and the second chip 220 are respectively similar to the first chip 110 and the second chip 120 described above. For the sake of brevity, similar parts will not be described again in detail in the present disclosure.

In the embodiment of the present disclosure, the touch analog circuit 211 outputs a target touch signal based on an initial touch signal in response to receiving the initial touch signal. The display analog circuit 212 receives a timing control signal and a display data signal, and outputs a gate drive signal and a data voltage signal based on the timing control signal and the display data signal.

In the embodiment of the present disclosure, the touch digital circuit 221 receives a target touch signal and outputs a touch data signal based on the target touch signal. In response to receiving an image data signal, the display digital circuit 222 outputs a timing control signal and a display data signal based on the image data signal.

For example, the touch analog circuit 211 may be an analog circuit of a TIC, and the touch digital circuit 221 may be a digital circuit of the TIC. The display analog circuit 212 may be an analog circuit of a DDIC, and the display digital circuit 222 may be a digital circuit of the DDIC.

In the embodiment of the present disclosure, when the display substrate 200 implements the touch function, the touch analog circuit 211 and the touch digital circuit 221 process signals representing touch information. For example, the touch analog circuit 211 and the touch digital circuit 221 may be connected via a communication interface. The touch analog circuit 211 receives an analog signal indicating the touch information from the touch display panel, converts the analog signal into a digital signal indicating the touch information, and then outputs the digital signal to the touch digital circuit 221. The touch digital circuit 221 generates touch data based on the digital signal indicating the touch information, and outputs the touch data to the main control unit, so as to enable the main control unit to generate corresponding image data based on the touch data.

In the embodiment of the present disclosure, when the display substrate 200 implements the display function, the display analog circuit 212 and the display digital circuit 222 process signals representing image data. For example, the display analog circuit 212 and the display digital circuit 222 may transmit signals based on an image transmission protocol.

For example, the display digital circuit 222 receives image data from the main control unit, converts the image data into a digital signal indicating image information, and then outputs the digital signal indicating the image information to the display analog circuit 212. The display analog circuit 212 may process the digital signal indicating the image information and convert the processed digital signal into an analog signal representing image data. The display analog circuit 212 outputs the analog signal to the touch display panel to cause the touch display panel to display the image data based on the analog signal.

Through the embodiment of the present disclosure, the analog circuits of the TIC and the analog circuits of the DDIC are integrated to form a Touch Analog & Driver Analog Circuit Integration (TDACI). The digital circuits of the TIC and the digital circuits of the DDIC are integrated to form a Touch Logical & Driver Logical Circuit Integration (TDLC). Based on the TDACI and the TDLCI, touch and display drive may be provided for the touch display panel. By optimizing the structures of the TDACI and the TDLCI, the process cost of the TDACI may be reduced, the leakage currents in the TDACI may be reduced, the static power consumption of the TDACI may be reduced, the degree of integration of the TDLCI may be improved, the area of the TDLCI may be reduced, and the dynamic power consumption of the TDLCI may be reduced.

Based on the above basic display structure, compared with the structure in which the DDIC is combined with the TIC, the basic display power consumptions of the structures TDACI and TDLCI may be reduced by more than 10%, and the cost may be reduced by more than 30%.

FIG. 3 shows a schematic structural diagram of a first chip according to an embodiment of the present disclosure. FIG. 3 shows a layout structure of a first chip 310.

As shown in FIG. 3, the first chip 310 includes a first control unit 311, a plurality of signal input/output interfaces 312_1, 312_2, a plurality of analog front ends 313_1, 313_2, a power management unit 314, source driver units 315_1, 315_2, a gamma correction unit 316, and gate driver units 317_1, 317_2.

In the embodiment of the present disclosure, the plurality of analog front ends are divided into two groups of analog front ends 313_1 and 313_2 respectively arranged on both sides of the first control unit 311 along a first direction. The power management unit 314 is arranged on a first side of the first control unit 311 along a second direction orthogonal to the first direction.

In the embodiment of the present disclosure, the source driver units 315_1 and 315_2, the plurality of signal input/output interfaces 312_1 and 312_2, the gate driver units 317_1 and 317_2, and the gamma correction unit 316 are arranged on a second side of the first control unit 311 along the second direction.

The source driver units are divided into two groups of source driver units 315_1 and 315_2 symmetrically distributed about the gamma correction unit 316, the gate driver units are divided into two groups of gate driver units 317_1 and 317_2 symmetrically distributed about the gamma correction unit 316, and the plurality of signal input/output interfaces are divided into two groups of signal input/output interfaces 312_1 and 312_2 symmetrically distributed about the gamma correction unit 316.

For example, the source driver unit 315_1, the signal input/output interface 312_1, and the gate driver unit 317_1 are sequentially distributed on one side of the gamma correction unit 316, and the source driver unit 315_2, the signal input/output interface 312_2, and the gate driver unit 317_2 are sequentially distributed on the other side of the gamma correction unit 316.

For example, the first control unit 311 may be a timing controller (TCON). The first control unit 311 controls touch signals, output signals of the source driver units 315_1, 315_2, and output signals of the gate driver units 317_1 and 317_2.

For example, the plurality of signal input/output interfaces 312_1 and 312_2 may include a transport (tx) interface and a receive (rx) interface. For example, a Tx electrode of the touch display panel may be voltage-driven via the signal output interface, and a Rx electrode of the touch display panel may be signal-driven via the signal input interface. The Tx electrode and the Rx electrode may be touch electrodes arranged in the touch display panel, and may receive touch signals from the touch display panel based on the signal input/output interfaces 312_1, 312_2.

For example, the plurality of analog front ends 313_1, 313_2 may be analog front ends (AFEs). The plurality of analog front ends 313_1 and 313_2 receive and process analog signals representing touch information. For example, the plurality of analog front ends 313_1, 313_2 may perform operations such as filtering and signal amplification on the initial touch signal.

For example, the gamma correction unit 316 may be a gamma voltage generator. The gamma voltage generator generates a gamma voltage and performs gamma correction on the signals in the circuit.

For example, the power management unit 314 may be a Power Management Circuit Integration (PMIC), the source driver units 3151, 3152 may be Source Driver Integrated Circuits (Source ICs), and the gate driver units 3171, 3172 may be Gate on Arrays (GOAs).

In the embodiment of the present disclosure, based on factors such as comprehensive power consumption and processing performance of basic display, data processing performance, design level of IC factory, and process capability of wafer factory, the first chip 310 includes digital intellectual properties (IPs) and analog IPs. For example, the first control unit 311 and the gate driver units 317_1, 317_2 are digital IPs.

In the embodiment of the present disclosure, a ratio of the total area of the first control unit 311, the plurality of signal input/output interfaces 312_1, 312_2, the plurality of analog front ends 313_1, 313_2, the power management unit 314, the source driver units 315_1, 315_2, the gamma correction unit 316 and the gate driver units 317_1, 317_2 included in the first chip 310 to the area of the first chip 310 is approximately 75% or more. A ratio of the area of the connecting lines among the IPs included in the first chip 310 to the area of the first chip 310 is approximately 25%. The connecting lines among the IPs may be Automatic Placement and Routing (APR), and the APR connecting lines among the IPs may be controlled by the first control unit 311.

FIG. 4 shows a schematic structural diagram of a second chip according to an embodiment of the present disclosure. FIG. 4 shows a layout structure of a second chip 420.

As shown in FIG. 4, the second chip 420 includes a second control unit 421, a storage unit 422, an oscillator 424, a voltage regulator 423, a first protocol interface 425, a second protocol interface 426, and a communication interface 427.

In the embodiment of the present disclosure, the storage unit 422 is arranged on a first side of the second control unit 421 along the second direction. The first protocol interface 425, the second protocol interface 426 and the communication interface 427 are arranged on a second side opposite to the first side of the second control unit 421 along the second direction, and the oscillator 424 and the voltage regulator 423 are arranged on a side of the second control unit 421 along the first direction orthogonal to the second direction.

For example, the second control unit 421 may be a TCON. For example, the second control unit 421 may include a display IP used to control a display process and a Micro Control Unit (MCU) used to control a touch process. The display IP and MCU are connected and communicated with each other. The MCU may read information such as touch display panel ID, display brightness and drive timing in the display IP, and automatically adjust the touch drive frequency based on the above information to avoid noise interference between the touch and the display. The MCU automatically adjusts the touch reporting rate according to the display brightness to reduce the touch power consumption. The MCU may also include a Digital Signal Processor (DSP). The display IP may read the reporting rate or touch operation information of the MCU and automatically change the display refresh rate to reduce the display power consumption.

For example, the storage unit 422 may be a Static Random-Access Memory (SRAM), the voltage regulator 423 may be a Low Dropout Regulator (LDO), the first protocol interface 425 may be a Mobile Industry Processor Interface (MIPI), the second protocol interface 426 may be an Internet Service Provider (ISP) protocol interface, and the communication interface 427 may be a Serial Peripheral Interface (SPI).

In the embodiment of the present disclosure, based on factors such as comprehensive power consumption and processing performance of basic display, data processing performance, design level of IC factory, and process capability of wafer factory, the second chip 420 includes digital IPs and analog IPs. For example, the voltage regulator 423, the first protocol interface 425, the second protocol interface 426, the communication interface 427, and the oscillator 424 are analog IPs.

In the embodiment of the present disclosure, some of the digital IPs and the analog IPs included in the second chip 420, such as the oscillator 424, may be shared between the first chip and the second chip. By sharing the digital IPs and the analog IPs, the chip area and the chip cost may be reduced.

In the embodiment of the present disclosure, a ratio of the total area of the digital IPs and the analog IPs included in the second chip 420 to the area of the second chip 420 is approximately 80% or more.

In the embodiment of the present disclosure, by optimizing the structure and the function of the second chip 420, the second chip 420 may be used as a low-configuration Graphics Processing Unit (GPU).

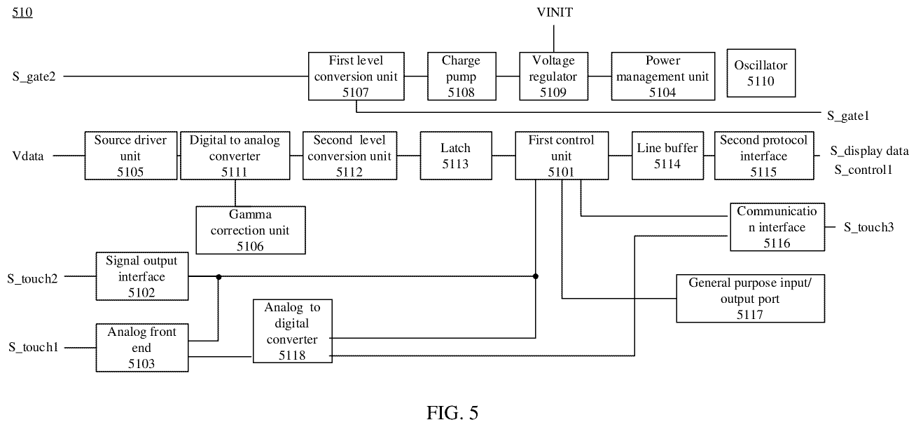

FIG. 5 shows a schematic structural diagram of a first chip according to another embodiment of the present disclosure.

As shown in FIG. 5, the first chip 510 includes a first control unit 5101, a signal output interface 5102, an analog front end 5103, a power management unit 5104, a source driver unit 5105, a gamma correction unit 5106, a first level conversion unit 5107, a charge pump 5108, a voltage regulator 5109, an oscillator 5110, a digital to analog converter 5111, a second level conversion unit 5112, a latch 5113, a line buffer 5114, a second protocol interface 5115, a communication interface 5116, a general purpose input/output port 5117, and an analog to digital converter 5118.

In the embodiment of the present disclosure, the first control unit 5101, the signal output interface 5102, the analog front end 5103, the power management unit 5104, the source driver unit 5105, the gamma correction unit 5106, the voltage regulator 5109, the oscillator 5110, the second protocol interface 5115 and the communication interface 5116 are similar to those described above and will not be repeated here for the sake of brevity.

For example, the first level conversion unit 5107 and the second level conversion unit 5112 are used to convert voltages of signals. The digital to analog converter 5111 is used to convert a digital signal into an analog signal. The analog to digital converter 5118 is used to convert an analog signal into a digital signal. The general purpose input/output port 5117 may be used as a backup interface to transmit a data signal. The charge pump 5108 may be a capacitive voltage converter. The latch 5113 may be a data latch. The line buffer 5114 may be a line buffer used to store image data of each line of pixels.

In the embodiment of the present disclosure, initial touch signals S_touch1, S_touch2 received via the signal output interface 5102 and the analog front end 5103 are processed by the first control unit 5101, the analog front end 5103 and the analog to digital converter 5118, so that a target touch signal S_touch3 is output via the communication interface 5116.

In the embodiment of the present disclosure, the first level conversion unit 5107 receives an initial gate drive signal S_gate1 from the second chip, and under the control of the charge pump 5108, the voltage regulator 5109 and the power management unit 5104, the first level conversion unit 5107 performs level conversion on the initial gate drive signal S_gate1 and outputs a target gate drive signal S_gate2. For example, the first level conversion unit 5107 may convert the voltage domain of the initial gate drive signal S_gate1 and amplify the voltage of the initial gate drive signal S_gate1 so that the target gate drive signal S_gate2 output to the touch display panel has a sufficient voltage to drive the touch display panel.

It should be noted that the gate driver unit that generates the initial gate drive signal S_gate1 is a digital IP integrated in the first chip 510, for example, see FIG. 3. The gate driver unit is not shown in FIG. 5, because FIG. 5 only shows some of the analog IPs included in the first chip 510.

The second protocol interface 5115 receives a source control signal S_control1 and a display data signal S_display data. The source control signal S_control1 and the display data signal S_display data sequentially pass through the line buffer 5114, the first control unit 5101, the latch 5113, the second level conversion unit 5112, the digital to analog converter 5111 and the source driver unit 5105, so as to output a source drive signal S_source.

In the embodiment of the present disclosure, the line buffer 5114 may cache data of the n-th line to facilitate receiving data of the (n+1)-th line. The latch 5113 may store the level of the display data signal. The second level conversion unit 5112 may convert the level of the display data signal, for example, increase the level of the display data signal.

In the embodiment of the present disclosure, the gamma correction unit 5106 may output a gamma voltage as a reference voltage. The source driver unit 5105 may divide the voltage of the analog signal output from the digital to analog converter 5111 based on the gamma voltage provided by the gamma correction unit 5106, so as to obtain a data voltage signal Vdata. The data voltage signal Vdata may represent grayscale values of a plurality of pixels in the image data.

In the embodiment of the present disclosure, the voltage regulator 5109 may output an initialization signal VINIT to the touch display panel, and the timing of the initialization signal VINIT is consistent with the timing of the target gate drive signal S_gate2. The initialization signal VINIT is output to the pixel array of the touch display panel.

In the embodiment of the present disclosure, the first control unit 5101 may be a secondary control unit of the second control unit in the second chip described above. The IPs of the first chip 510 are all controlled by the second chip.

It should be noted that the structure and the signal processing flow of the first chip 510 shown in FIG. 5 are only for schematic illustration, and the first chip 510 includes but is not limited to the above IP. The structure and the signal processing flow of the first chip 510 are not defined in the present disclosure.

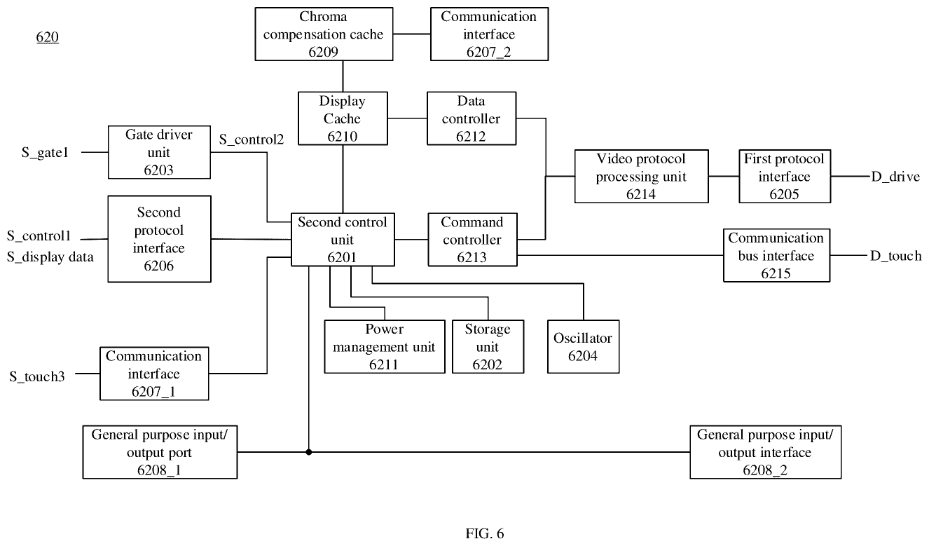

FIG. 6 shows a schematic structural diagram of a second chip according to another embodiment of the present disclosure.

As shown in FIG. 6, the second chip 620 includes a second control unit 6201, a storage unit 6202, a gate driver unit 6203, an oscillator 6204, a first protocol interface 6205, a second protocol interface 6206, a communication interface 6207_1, a communication interface 6207_2, a general purpose input/output port 6208_1, a general purpose input/output port 6208_2, a chroma compensation buffer 6209, a display cache 6210, a power management unit 6211, a data controller 6212, a command controller 6213, a video protocol processing unit 6214 and a communication bus interface 6215.

In the embodiment of the present disclosure, the second control unit 6201, the storage unit 6202, the gate driver unit 6203, the oscillator 6204, the first protocol interface 6205, the second protocol interface 6206, the communication interface 6207_1, the communication interface 6207_2, the general purpose input/output port 6208_1, the general purpose input/output port 6208_2, and the power management unit 6211 are similar to those described above and will not be repeated here for the sake of brevity.

For example, the chroma compensation buffer 6209 is used to eliminate chroma unevenness in image data. The display cache 6210 is used to cache image data. The data controller 6212 may be a data control used to control the transmission of image data. The command controller 6213 may be a Command control (CMD CTL) for controlling a processing command of image data. The video protocol processing unit 6214 processes image data based on the Video Electronics Standards Association (VESA) standard. The communication bus interface 6215 may be an Inter Integrated Circuit (I2C) or an Improved Inter Integrated Circuit (I3C).

In the embodiment of the present disclosure, a target touch signal S_touch3 is received via the communication interface 6207_1, the target touch signal S_touch3 is processed by the second control unit 6201 and the command controller 6213, so that a touch data signal D_touch is output via the communication bus interface 6215.

In the embodiment of the present disclosure, an image data signal D_drive is received via the first protocol interface 6205, the image data signal D_drive is processed by the chroma compensation buffer 6209, the display cache 6210, the data controller 6212, the command controller 6213 and the video protocol processing unit 6214, and a gate control signal S_control2 is output. The gate driver unit 6203 outputs an initial gate drive signal S_gate1 based on the gate control signal S_control2.

It should be noted that, structurally, the gate driver unit 6203 is integrated into, for example, the first chip 510, as shown in FIG. 3. Functionally, the gate driver unit 6203 is a digital IP. FIG. 6 shows some IPs belonging to the digital IPs in the second chip 620, and therefore the gate driver unit 6203 is shown in FIG. 6.

In the embodiment of the present disclosure, the image data signal D_drive is processed by the chroma compensation buffer 6209, the display cache 6210, the data controller 6212, the command controller 6213 and the video protocol processing unit 6214, and the source control signal S_control1 and the display data signal S_display data are output via the second protocol interface 6206.

In the embodiment of the present disclosure, the chroma compensation buffer 6209 may be electrically connected to a flash via the communication interface 6207_2 to obtain information in the flash, thereby eliminating the problem of uneven chroma in the image data indicated by the data signal.

In the embodiment of the present disclosure, the general purpose input/output port 6208_1 and the general purpose input/output port 6208_2 may be used to transmit a reset signal, an interrupt signals, etc.

In the embodiment of the present disclosure, the power management unit 6211 is controlled by the main control unit.

It should be noted that the structure and the signal processing flow of the second chip 620 shown in FIG. 6 are only for schematic illustration, and the second chip 620 includes but is not limited to the above IP. The structure and the signal processing flow of the second chip 620 are not defined in the present disclosure.

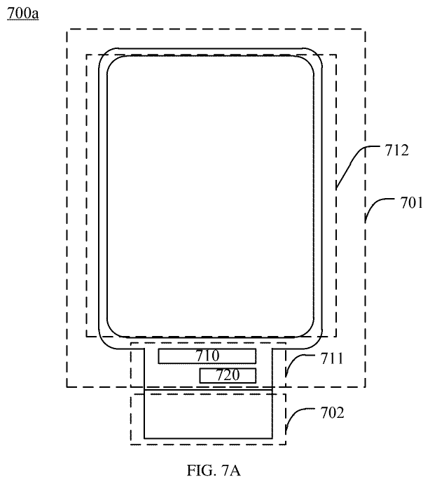

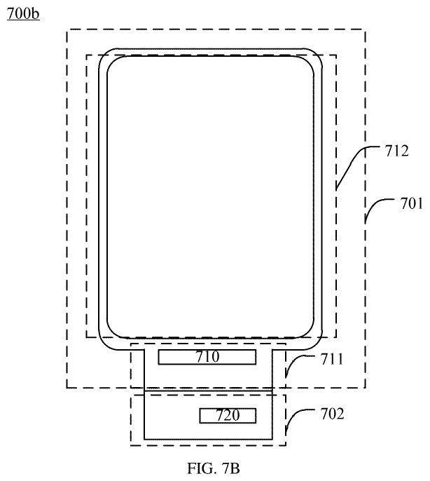

FIG. 7A shows a schematic structural diagram of a display device according to an embodiment of the present disclosure.

As shown in FIG. 7A, a display device 700a includes a touch display panel 701 including a non-display area 711 and a display area 712 and a flexible circuit board 702.

In the embodiment of the present disclosure, the display area 712 is used to display images. The first chip 710 and the second chip 720 are both arranged in the non-display area 711 of the touch display panel 701.

In the embodiment of the present disclosure, the first chip 710 and the second chip 720 may be bonded on the touch display panel 701 using Chip On Pi (COP) technology.

In the embodiment of the present disclosure, the flexible circuit board 702 may be located between the touch display panel 701 and a main board on which the main control unit is disposed. A component area may also be arranged on the flexible circuit board 702. The component area may include components such as capacitor, resistors, transient voltage suppressors (TVSs), and flash.

In the embodiment of the present disclosure, the flash may also be packaged in the second chip 720.

FIG. 7B shows a schematic structural diagram of a display device according to another embodiment of the present disclosure.

As shown in FIG. 7B, a display device 700b includes a touch display panel 701 including a non-display area 711 and a display area 712 and a flexible circuit board 702.

In the embodiment of the present disclosure, the display area 712 is used to display images. The first chip 710 is arranged in the non-display area 711 of the touch display panel 701, and the second chip 720 is arranged on the flexible circuit board 702.

In the embodiment of the present disclosure, the first chip 710 may be bonded on the touch display panel 701 by using Chip On Pi (COP) technology. The second chip 720 may be packaged using a packaging technology such as Ball Gate Array (BGA) technology, Wafer Level Chip Scale Packaging (WLCSP) technology or Fanout technology, and the second chip 720 may be arranged on the flexible circuit board 702 using Surface Mount Technology (SMT).

In the embodiment of the present disclosure, a component area may also be arranged on the flexible circuit board 702. The component area may include components such as capacitors, resistors, TVS and flash. The flash may also be packaged in the second chip 720.

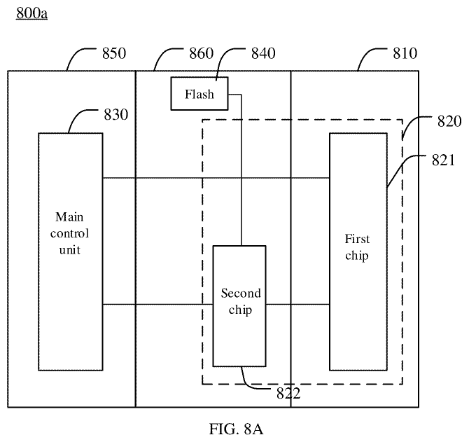

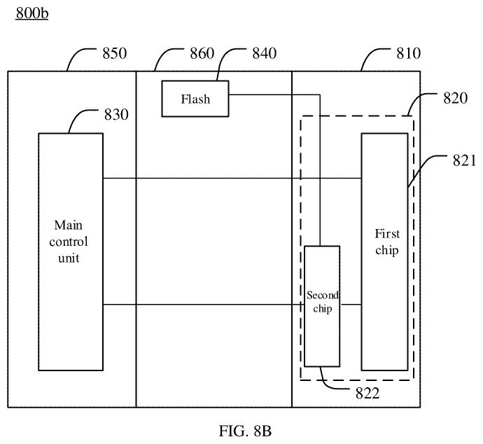

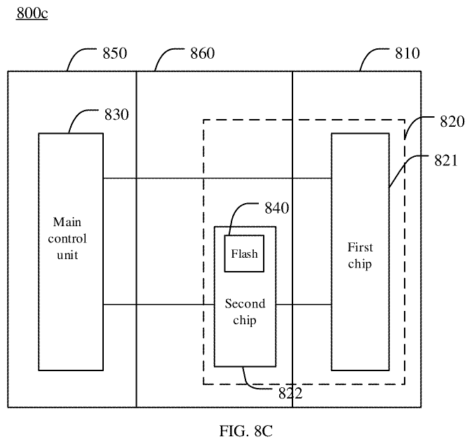

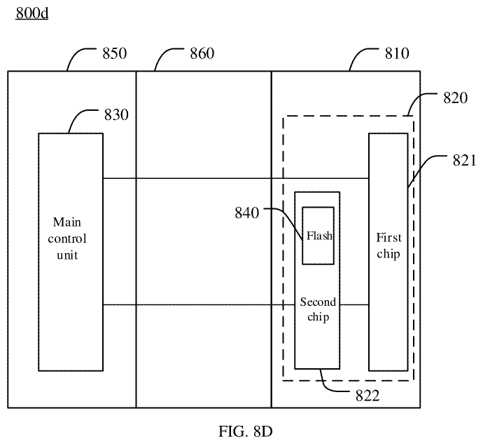

FIG. 8A shows a schematic structural diagram of a display device according to another embodiment of the present disclosure.

As shown in FIG. 8A, a display device 800a includes a touch display panel 810, a display substrate 820, a main control unit 830, a flash 840, a main board 850, and a flexible circuit board 860.

In the embodiment of the present disclosure, the display substrate 820 may be similar to the display substrate 100 and the display substrate 200 described above, and will not be repeated here for the sake of brevity.

In the embodiment of the present disclosure, the touch display panel 810 is electrically connected to the display substrate 820, and the main control unit 830 is electrically connected to the display substrate 840.

In the embodiment of the present disclosure, the touch display panel 810 generates an initial touch signal in response to a received touch operation. The display substrate 820 generates a target touch signal based on the initial touch signal, and outputs a touch data signal based on the target touch signal. The main control unit 830 generates a display data signal based on the touch data signal. The display substrate 820 also generates a timing control signal and a display data signal based on the image data signal, and outputs a gate drive signal and a data voltage signal to the touch display panel 810 based on the timing control signal and the display data signal.

In the embodiment of the present disclosure, the display substrate 820 includes a first chip 821 and a second chip 822. The first chip 821 is similar to the first chip 210, the first chip 310, and the first chip 510 described above, and the second chip 822 is similar to the second chip 220, the second chip 420, and the second chip 620 described above. They are not repeated here for the sake of brevity.

In the embodiment of the present disclosure, the flexible circuit board 860 is located between the main board 850 and the touch display panel 810. The first chip 821 is arranged in the non-display area of the touch display panel 810, and the second chip 822 is arranged on the flexible circuit board 840. The main control unit 830 is arranged on the main board 850. The main control unit 830 may include a System on Chip (SOC) and a direct current/direct current (DC/DC) converter.

In the embodiment of the present disclosure, the flash 840 is arranged on the flexible circuit board 860, and electrically connected to the second chip 822. For example, the second chip 822 is electrically connected to the flash 840 via a communication interface. The second chip 822 may be provided with 6 pins as a communication interface connected to the flash 840. The flash 840 may also be connected to the main control unit 830 via a power interface VDDIO, and the main control unit 830 may provide a drive voltage of 1.8V to the flash 840 via the power interface VDDIO.

In the embodiment of the present disclosure, the first chip 821 is electrically connected to the second chip 822 via the second protocol interface, a plurality of communication interfaces, the first interrupt interface, the synchronization signal interface, and the gate signal input interface.

For example, the second protocol interface may be an ISP protocol interface. The first chip 821 and the second chip 822 may be respectively provided with 6 pins or 12 pins as ISP protocol interfaces. The ISP protocol interface of the first chip 821 may be an input interface, and the ISP protocol interface of the second chip 822 may be an output interface. Image information may be transmitted between the second chip 822 and the first chip 821 via an ISP protocol interface based on the ISP protocol.

For example, image information may also be transmitted between the second chip 822 and the first chip 821 via a MIPI interface, a Low-Voltage Differential Signaling (LVDS) interface, or an Embedded Display Port (eDP).

For example, the plurality of communication interfaces may be SPI interfaces. For example, the SPI interface may be a Quad SP1 interface, and the first chip 821 and the second chip 822 may be respectively provided with 6 pins as the SPI interface. Touch information may be transmitted between the second chip 822 and the first chip 821 via an SPI interface.

For example, the SPI interfaces include two groups of SPI interfaces. The two groups of SPI interfaces may be respectively used to transmit a touch signal and a display signal. The touch signal is transmitted from the first chip 821 to the second chip 822, and the display signal is transmitted from the second chip 822 to the first chip 821.

The SPI interfaces also include at least two reserved SPI interfaces. One second chip 822 may be connected to at least two first chips 821 via at least two SPI interfaces, so that the at least two first chips 821 form a cascade connection, thereby allowing the display substrate to provide a drive for a large-size display panel.

For example, the first interrupt interface is used to transmit an interrupt signal INT between the first chip 821 and the second chip 822. The first chip 821 and the second chip 822 may be respectively provided with 1 pin as a first interrupt interface.

For example, a synchronization signal interface is used to transmit a clock synchronization signal Sync between the first chip 821 and the second chip 822. The first chip 821 and the second chip 822 may be respectively provided with 2 pins as the first interrupt interface.

For example, a gate signal input interface GOA I/O is used to transmit a timing control signal for generating a gate drive signal between the first chip 821 and the second chip 822. The first chip 821 and the second chip 822 may be respectively provided with 25 pins as the gate signal input interface.

For example, the first chip 821 and the second chip 822 share a common ground via a first ground interface GND, and the first ground interface GND may also isolate a signal transmitted by the ISP protocol interface. The first chip 821 and the second chip 822 may be respectively provided with 4 pins as the first ground interface.

In the embodiment of the present disclosure, the first chip 821 is electrically connected to the main control unit 830 via a first power interface and a first reset interface.

For example, the first power interface may include a power interface VDDIO for supplying power to an interface, a power interface VIC for supplying power to a core IP in the first chip 821, and an analog power interface AVDD. The main control unit 830 provides a power voltage of 1.8V to the first chip 821 via the power interface VDDIO. The first chip 821 is provided with 1 pin as the power interface VDDIO. The main control unit 830 provides a power voltage of 3.0-3.3V to the first chip 821 via the power interface VIC. The first chip 821 is provided with 1 pin as the power interface VIC. The main control unit 830 provides a power voltage of 7.6-7.9V to the first chip 821 via the analog power interface AVDD. The first chip 821 is provided with 1 pin as the analog power interface AVDD.

For example, the first chip 821 and the main control unit 830 share a common ground via a second ground interface. The first chip 821 may be provided with 3 pins as the second ground interface. In order to increase circuit reliability, the first chip 821 may reserve a plurality of pins as the second ground interface.

For example, the first reset interface is used to output a reset signal RST from the main control unit 830 to the first chip 821. The first chip 821 may be provided with 2 pins as the first reset interface.

For example, the first chip 821 may be further provided with 3 pins as a General Purpose Input/Output Ports (GPIOs). The GPIO interface is used as a reserved signal interface.

In the embodiment of the present disclosure, the first chip 821 is electrically connected to the touch display panel 810 via a gate signal output interface, a source signal output interface, a signal input/output interface, an initialization interface, and a shield signal interface.

For example, the first chip 821 and the touch display panel 810 share a common ground via a third ground interface.

For example, the gate signal output interface is used to output a gate drive signal to the touch display panel 810, and the source signal output interface is used to output a source drive signal to the touch display panel 810. For example, in the case that the touch display panel 810 includes 2560 lines of pixels, the source drive signal includes 2560 lines of scanning signals.

For example, the signal input/output interface includes a signal input interface and a signal output interface. The Rx electrode of the touch display panel 810 may be signal-driven via the signal input interface. The Tx electrode of the touch display panel 810 may be voltage-driven via the signal output interface.

For example, the first chip 821 may output an initialization signal to the touch display panel 810 via the initialization interface, and the initialization signal is synchronized with the gate drive signal.

For example, the shield signal interface is used to output a shield signal Guard/Shield from the first chip 821 to the touch display panel 810.

For example, the first chip 821 may also detect whether the touch display panel 810 is cracked via a Panel Crack Detection (PCD) interface.

In the embodiment of the present disclosure, the second chip 822 is electrically connected to the main control unit 830 via a power control interface, a second power interface, a general purpose input/output port, a first protocol interface, a second reset interface, a second interrupt interface, a communication bus interface and a communication interface.

In the embodiment of the present disclosure, the power control interface, the second reset interface, the second power interface, and the first protocol interface may process a display signal. The second power interface, the general purpose input/output port, the second reset interface, the second interrupt interface, the communication bus interface, and the communication interface may process a touch signal.

For example, the power control interface may include a power control interface AVDD_EN for powering on AVDD and a power control interface SWIRE_IN for controlling the power of the main control unit 830 based on single-wire control. The second chip 822 may be provided with 1 pin as the power control interface AVDD_EN, and the second chip 822 may be provided with 1 pin as the power control interface SWIRE_IN.

For example, the second power interface may include a power interface L_VDDI, a power interface L_DVDDIO, a power interface L_DVDD, a power interface L_DVDDP, and a power interface L_DVDD_TP.

The main control unit 830 provides a power voltage of 1.65-1.95V to the second chip 822 via the power interface L_VDDI, and the second chip 822 is provided with 1 pin as the power interface L_VDDI. The main control unit 830 provides a power voltage of 1.2-1.95V to the second chip 822 via the power interface L_DVDDIO, and the first chip 821 is provided with 1 pin as the power interface L_DVDDIO. A power voltage of 1.2-1.95V is externally supplied to the second chip 822 via the power interface L_DVDD, and the second chip 822 is provided with 1 pin as the power interface L_DVDD. A power voltage of 1.2-1.95V is externally supplied to the second chip 822 via the power interface L_DVDDP, and the second chip 822 is provided with one pin as the power interface L_DVDDP. A power voltage of 1.2-1.95V is externally supplied to the second chip 822 via the power interface L_DVDD_TP, and the second chip 822 is provided with 1 pin as the power interface L_DVDD_TP.

The power interface L_DVDD and the power interface L_DVDDP are power interfaces for driving a display process, and the power interface L_DVDD_TP is a power interface for driving a touch process. The second chip 822 is driven based on the power voltage at the power interface L_DVDD_TP, the power interface L_DVDD, and the power interface L_DVDDP, so that the power consumption of the second chip 822 may be reduced.

For example, the general purpose input/output port may be a GPIO interface. Via the GPIO interface, the main control unit 830 may acquire the operating status of the second chip 822 and may also identify errors or abnormalities that occur in the second chip 822. The second chip 822 may be provided with 2 pins as the GPIO interface.

For example, the first protocol interface may be a MIPI interface. The MIPI interface may include a D-PHY interface and a C-PHY interface. The main control unit 830 may output a display data signal to the second chip 822 via the MIPI interface. The second chip 822 may be provided with 22 pins as the first protocol interface. The D-PHY interface in the MIPI interface may be connected with 10 signal lines, and the C-PHY interface may be connected with 9 signal lines.

For example, the second reset interface is used to output a reset signal RST from the main control unit 830 to the second chip 822. The second chip 822 may be provided with 2 pins as the second reset interface.

For example, the second interrupt interface is used to output the touch interrupt signal INT from the main control unit 830 to the second chip 822. The second chip 822 may be provided with 1 pin as the second reset interface.

For example, the communication bus interface may include an L_I2C interface and an L_I3C interface. The second chip 822 outputs the touch data signal to the main control unit 830 via the communication bus interface. The second chip 822 may be provided with 2 pins as the communication bus interface.

For example, the communication interface may be an SPI interface. The second chip 822 may also output the touch data signal to the main control unit 830 via the communication bus interface. The second chip 822 may be provided with 4 pins as the communication bus interface.

For example, the second chip 822 and the main control unit 830 share a common ground via a fourth ground interface. The second chip 822 may be provided with 8 pins as the fourth ground interface.

For example, the second chip 822 may further send feedback information to the main control unit 830 via a transmission interface, and the feedback information represents that display data of a frame of display image has been transmitted.

In the embodiment of the present disclosure, the actual shape of the second chip 822 is close to a square, which may be beneficial to increasing the cutting utilization rate of a wafer.

Through the embodiment of the present disclosure, by designing the pins of the first chip 821 and the second chip 822, specifying the definition of each pin, fixing the pin mapping of the first chip 821 and the second chip 822, and designing the pins of the first chip 821 and the second chip 822 into a public version bump design, a public version touch display analog chip (the first chip 821 and the second chip 822) may be formed, so that the first chip 821 and the second chip 822 may be standardized, which facilitates the design, tape-out and production of the first chip 821 and the second chip 822.

FIG. 8B shows a schematic structural diagram of a display device according to another embodiment of the present disclosure.

As shown in FIG. 8B, the display device 800b includes a touch display panel 810, a display substrate 820, a main control unit 830, a flash 840, a main board 850, and a flexible circuit board 860.

In the embodiment of the present disclosure, the first chip 821 and the second chip 822 are arranged in the non-display area of the touch display panel 810. The flash 840 is arranged on the flexible circuit board 860, and the second chip 822 is electrically connected to the flash 840 via a communication interface.

In the embodiment of the present disclosure, the connection relationships among the touch display panel 810, the display substrate 820, the main control unit 830, the flash 840, and the main board 850 in the display device 800b are similar to those in the display device 800a. They are not repeated here for the sake of brevity.

FIG. 8C shows a schematic structural diagram of a display device according to another embodiment of the present disclosure.

As shown in FIG. 8C, the display device 800c includes a touch display panel 810, a display substrate 820, a main control unit 830, a flash 840, a main board 850, and a flexible circuit board 860.

In the embodiment of the present disclosure, the first chip 821 is arranged in the non-display area of the touch display panel 810, and the second chip 822 is arranged on the flexible circuit board 860.

In the embodiment of the present disclosure, the flash 840 is packaged inside the second chip 840. For example, the flash 840 may be packaged inside the second chip 840 using e-Flash process or BGA packaging technology.

In the embodiment of the present disclosure, the connection relationships among the touch display panel 810, the display substrate 820, the main control unit 830, the flash 840, and the main board 850 in the display device 800b are similar to those in the display device 800a. They are not repeated here for the sake of brevity.

FIG. 8D shows a schematic structural diagram of a display device according to another embodiment of the present disclosure.

As shown in FIG. 8D, the display device 800d includes a touch display panel 810, a display substrate 820, a main control unit 830, a flash 840, a main board 850, and a flexible circuit board 860.

In the embodiment of the present disclosure, the first chip 821 and the second chip 822 are arranged in the non-display area of the touch display panel 810. The flash 840 is packaged inside the second chip 840. For example, the flash 840 may be packaged inside the second chip 840 using e-Flash process or BGA packaging technology.

In the embodiment of the present disclosure, the connection relationships among the touch display panel 810, the display substrate 820, the main control unit 830, the flash 840, and the main board 850 in the display device 800b are similar to those in the display device 800a. They are not repeated here for the sake of brevity.

The block diagrams in the accompanying drawings illustrate system architectures, functions, and operations that may be implemented by the system, the method, and the computer program product according to various embodiments of the present disclosure. In this regard, each box in the flow diagram or block diagram may represent a module, a program segment, or a portion of a code. The module, the program segment, or the portion of a code contains one or more executable instructions for implementing the specified logical functions. It should also be noted that, in some alternative implementations, the functions noted in the blocks may occur in an order different from the order noted in the drawings. For example, two blocks shown in succession may, in fact, be executed substantially concurrently, or they may sometimes be executed in a reverse order, depending upon the functions involved. It should also be noted that each box in the block diagram or flow diagram and combinations of boxes in the block diagram or flow diagram may be implemented by a dedicated hardware-based system that executes the specified functions or operations, or may be implemented by a combination of dedicated hardware and computer instructions.

Those skilled in the art may understand that various combinations and/or conjunctions of the features described in various embodiments and/or claims of the present disclosure may be made, even if such combinations or conjunctions are not explicitly described in the present disclosure. In particular, various combinations and/or conjunctions of the features described in various embodiments and/or claims of the present disclosure may be made without departing from the spirit and teachings of the present disclosure. All such combinations and/or conjunctions fall within the scope of the present disclosure.

The embodiments of the present disclosure are described above. However, these embodiments are for illustrative purposes only and are not intended to limit the scope of the present disclosure. Although various embodiments are described above separately, this does not mean that measures in various embodiments may not be used advantageously in combination. The scope of the present disclosure is defined by the appended claims and the equivalents thereof. Without departing from the scope of the present disclosure, those skilled in the art may make various substitutions and modifications, and all these substitutions and modifications should fall within the scope of the present disclosure.

1. A display substrate, comprising:
a first chip configured to output, in response to receiving an initial touch signal from a touch display panel, a target touch signal based on the initial touch signal; and
a second chip electrically connected to the first chip and configured to output a touch data signal to a main control unit based on the target touch signal, and output, in response to receiving an image data signal from the main control unit, a timing control signal and a display data signal based on the image data signal;
wherein the first chip is further configured to receive the timing control signal and the display data signal, and output a gate drive signal and a data voltage signal to the touch display panel based on the timing control signal and the display data signal.

2. The display substrate according to claim 1, wherein the first chip comprises:
a touch analog circuit configured to output, in response to receiving the initial touch signal, the target touch signal based on the initial touch signal; and
a display analog circuit configured to receive the timing control signal and the display data signal, and output the gate drive signal and the data voltage signal based on the timing control signal and the display data signal.

3. The display substrate according to claim 1, wherein the second chip comprises:
a touch digital circuit configured to receive the target touch signal and output a touch data signal based on the target touch signal; and
a display digital circuit configured to output, in response to receiving the image data signal, the timing control signal and the display data signal based on the image data signal.

4. The display substrate according to claim 1, wherein the first chip comprises: a first control unit, a plurality of signal input/output interfaces, a plurality of analog front ends, a power management unit, a source driver unit, a gamma correction unit, and a gate driver unit.

5. The display substrate according to claim 1, wherein the second chip comprises: a storage unit, a second control unit, an oscillator, a voltage regulator, a first protocol interface, a second protocol interface, and a communication interface.

6. The display substrate according to claim 4, wherein
the plurality of analog front ends are divided into two groups of analog front ends respectively arranged on both sides of the first control unit along a first direction;
the power management unit is arranged on a first side of the first control unit along a second direction orthogonal to the first direction; and
the source driver unit, the plurality of signal input/output interfaces, the gate driver unit and the gamma correction unit are arranged on a second side of the first control unit along the second direction;
wherein the source driver unit is divided into two groups of source driver units symmetrically distributed about the gamma correction unit, the gate driver unit is divided into two groups of gate driver units symmetrically distributed about the gamma correction unit, and the plurality of signal input/output interfaces are divided into two groups of signal input/output interfaces symmetrically distributed about the gamma correction unit.

7. The display substrate according to claim 5, wherein
the storage unit is arranged on a first side of the second control unit along a second direction;
the first protocol interface, the second protocol interface and the communication interface are arranged on a second side of the second control unit along the second direction; and
the oscillator and the voltage regulator are arranged on a side of the second control unit along a first direction orthogonal to the second direction.

8. The display substrate according to claim 1, wherein the first chip is arranged in a non-display area of the touch display panel.

9. The display substrate according to claim 8, wherein the second chip is arranged in the non-display area of the touch display panel.

10. The display substrate according to claim 8, wherein the second chip is arranged on a flexible circuit board between the touch display panel and a main board, wherein the main control unit is disposed on the main board.

11. The display substrate according to claim 9, further comprising:
a flash memory electrically connected to the second chip and arranged on a flexible circuit board between the touch display panel and a main board.

12. The display substrate according to claim wherein the second chip further comprises a flash memory packaged inside the second chip.

13. The display substrate according to claim 11, wherein the second chip is electrically connected to the flash memory via a communication interface.

14. The display substrate according to claim 1, wherein the first chip is electrically connected to the second chip via a second protocol interface, a plurality of communication interfaces, a first interrupt interface, a synchronization signal interface, and a gate signal input interface, and the first chip and the second chip share a common ground via a first ground interface.

15. The display substrate according to claim 1, wherein the first chip is electrically connected to the main control unit via a first power interface and a first reset interface, and the first chip and the main control unit share a common ground via a second ground interface.

16. The display substrate according to claim 1, wherein the first chip is electrically connected to the touch display panel via a gate signal output interface, a source signal output interface, a signal input/output interface, an initialization interface, and a shield signal interface, and the first chip and the touch display panel share a common ground via a third ground interface.

17. The display substrate according to claim 1, wherein the second chip is electrically connected to the main control unit via a power control interface, a second power interface, a general purpose input/output port, a first protocol interface, a second reset interface, a second interrupt interface, a communication bus interface and a communication interface, and the second chip and the main control unit share a common ground via a fourth ground interface.

18. A display device, comprising:
a touch display panel configured to generate an initial touch signal in response to a received touch operation;
the display substrate according to claim 1, electrically connected to the touch display panel and configured to generate the target touch signal based on the initial touch signal, and output the touch data signal based on the target touch signal; and
the main control unit electrically connected to the display substrate and configured to generate the image data signal based on the touch data signal;
wherein the display substrate is further configured to generate the timing control signal and the display data signal based on the image data signal, and output the gate drive signal and the data voltage signal to the touch display panel based on the timing control signal and the display data signal.

19. The display substrate according to claim 10, further comprising:
a flash memory electrically connected to the second chip and arranged on a flexible circuit board between the touch display panel and a main board.

20. The display substrate according to claim 10, wherein the second chip further comprises a flash memory packaged inside the second chip.
